(19) United States
(12) Patent Application Publication
(10) Pub. No.: US 2025/0376340 A1
(43) Pub. Date: Dec. 11, 2025

(54) GLASS CARRIER

(71) Applicant: LIH YANN INDUSTRIAL CO., LTD., Taichung City (TW)

(72) Inventor: Po-Lin LIAO, Taichung City (TW)

(21) Appl. No.: 18/734,780

(22) Filed: Jun. 5, 2024

(51) Int. Cl. B65G 49/06

(52) U.S. Cl. CPC B65G 49/061; B65G 2249/045

(57) ABSTRACT

A glass carrier is provided, wherein the glass carrier includes: a frame including two frame bodies, the two frame bodies being connected to each other and angularly adjustable relative to each other; and a plurality of suction devices connected to the two frame bodies respectively, each of the suction devices including a suction cup including an attachment surface configured to be air-tightly attached to a surface of a glass member; wherein an angle between the attachment surfaces of two of the suction cups of the plurality of suction devices which are disposed respectively on the two frame bodies is adjustable by adjusting an angle between the two frame bodies.

### BACKGROUND OF THE INVENTION

The present invention relates to a glass carrier.

### DESCRIPTION OF THE PRIOR ART

In a suction device, the air in the suction cup is evacuated to generate negative pressure and suction force for attachment to the surface of an object. Therefore, the carrier with the suction cup has been widely used to transport items such as large glass, tiles, etc. It is conducive to grip and safely moving objects, and can avoid damaging the surface of the object.

Generally, a conventional carrier is provided with a plurality of suction cups disposed on a frame, and the plurality of suction cups are used to attach to an object such as glass or the like. However, the frame of the conventional carrier has a fixed structure and cannot be adjusted, so it can only be applied to objects such as glass with flat surfaces. In the application of objects such as glass with curved or angled surfaces, the plurality of suction cups cannot be effectively and flatly attached to the curved or angled surfaces. As such, it has deficiencies on the moving operation of the conventional carrier, and there are great uncertain concerns about safety.

The present invention is, therefore, arisen to obviate or at least mitigate the above-mentioned disadvantages.

### SUMMARY OF THE INVENTION

The main object of the present invention is to provide a glass carrier which can be adjusted within a large range to effectively attach to various glass surfaces.

To achieve the above and other objects, the present invention provides a glass carrier is provided, wherein the glass carrier includes: a frame including two frame bodies, the two frame bodies being connected to each other and angularly adjustable relative to each other; and a plurality of suction devices connected to the two frame bodies respectively, each of the suction devices including a suction cup including an attachment surface configured to be air-tightly attached to a surface of a glass member; wherein an angle between the attachment surfaces of two of the suction cups of the plurality of suction devices which are disposed respectively on the two frame bodies is adjustable by adjusting an angle between the two frame bodies.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a partial enlarged view of an exemplary embodiment of the present invention;

FIG. 3 is a breakdown drawing of an exemplary embodiment of the present invention;

FIG. 4 is a cross-sectional view of an exemplary embodiment of the present invention;

FIG. 5 is a partial stereogram of an exemplary embodiment of the present invention; and

FIG. 6 is a drawing showing an application of a glass carrier of an exemplary embodiment of the present invention.

### DETAILED DESCRIPTION OF THE PREFERRED EMBODIMENTS

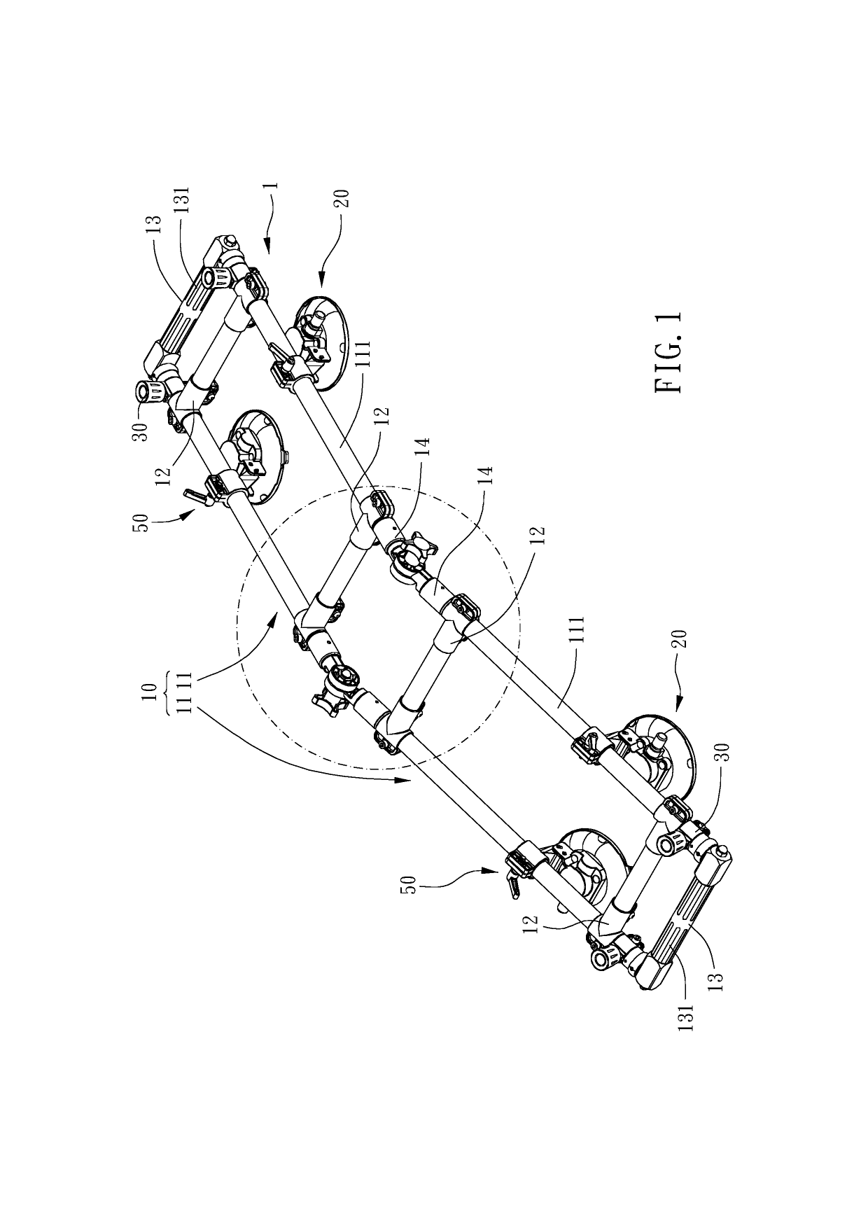

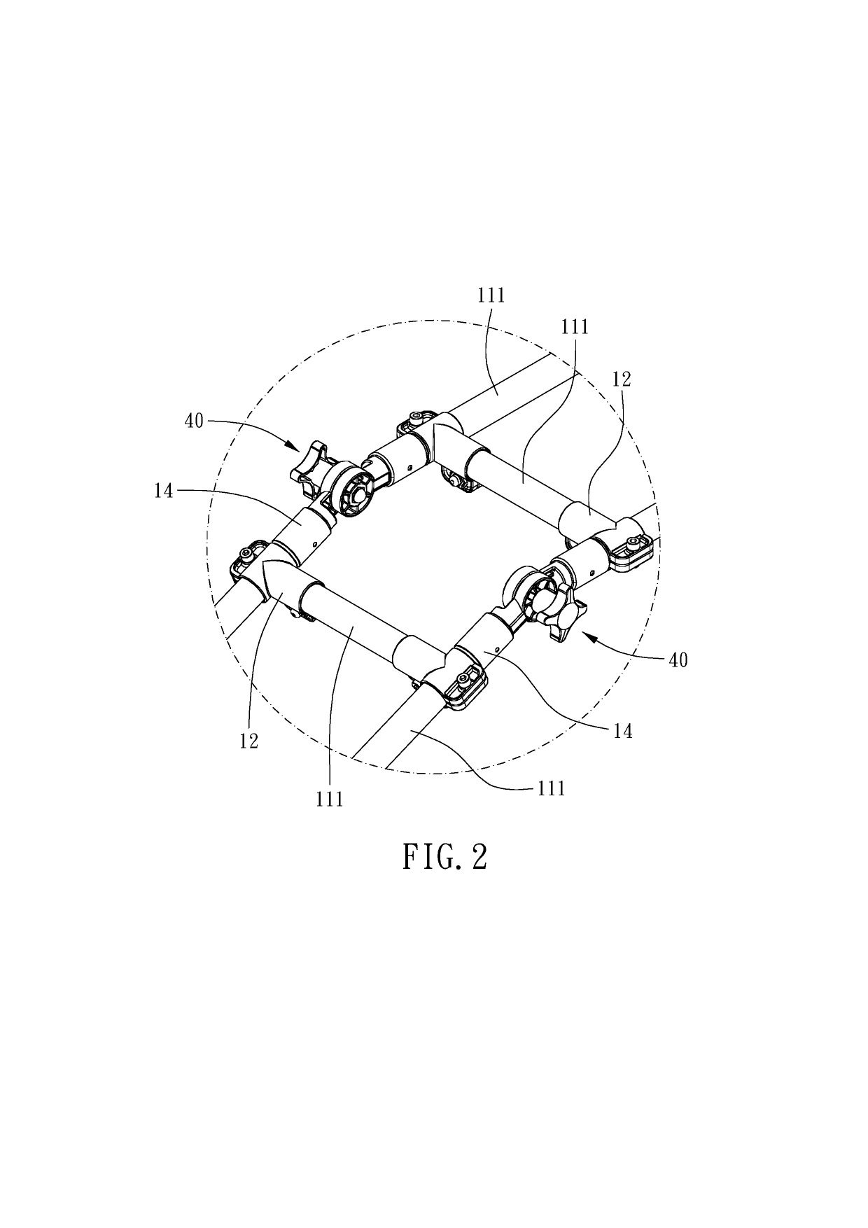

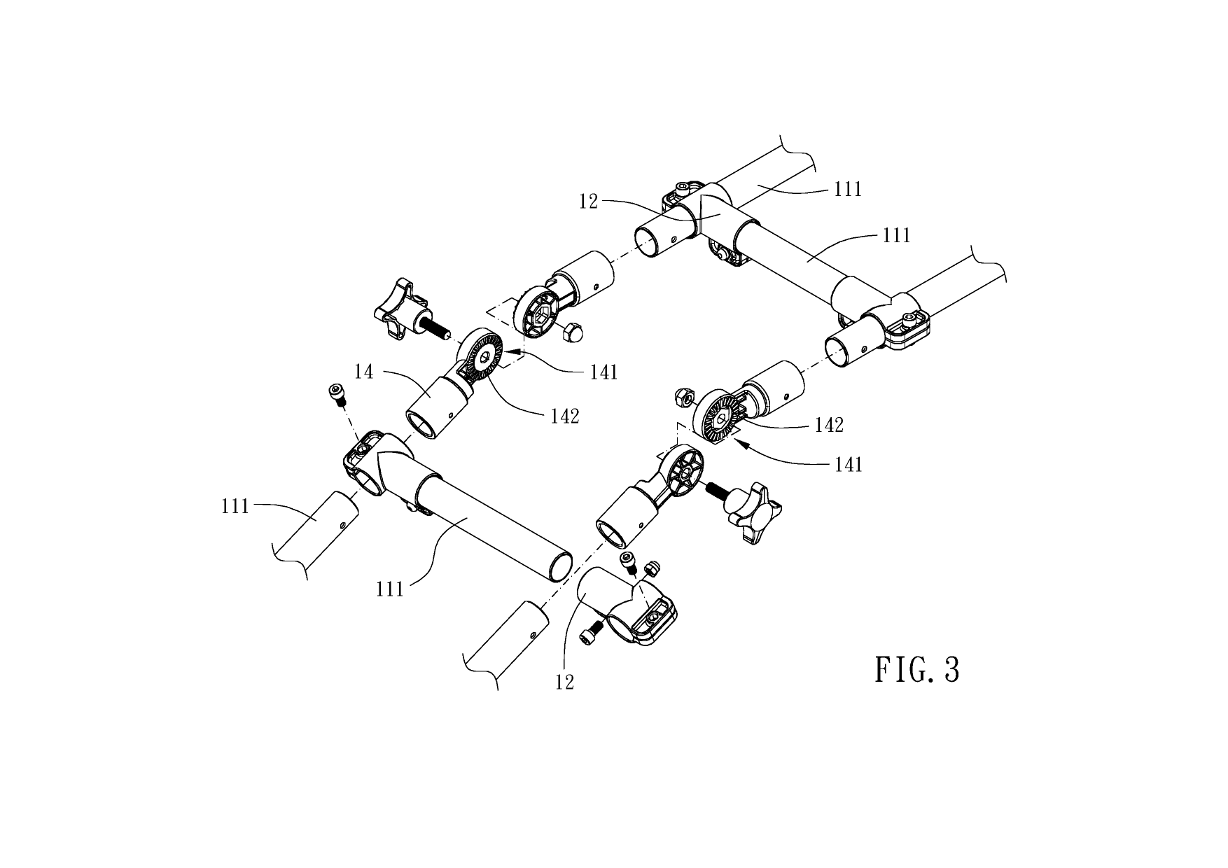

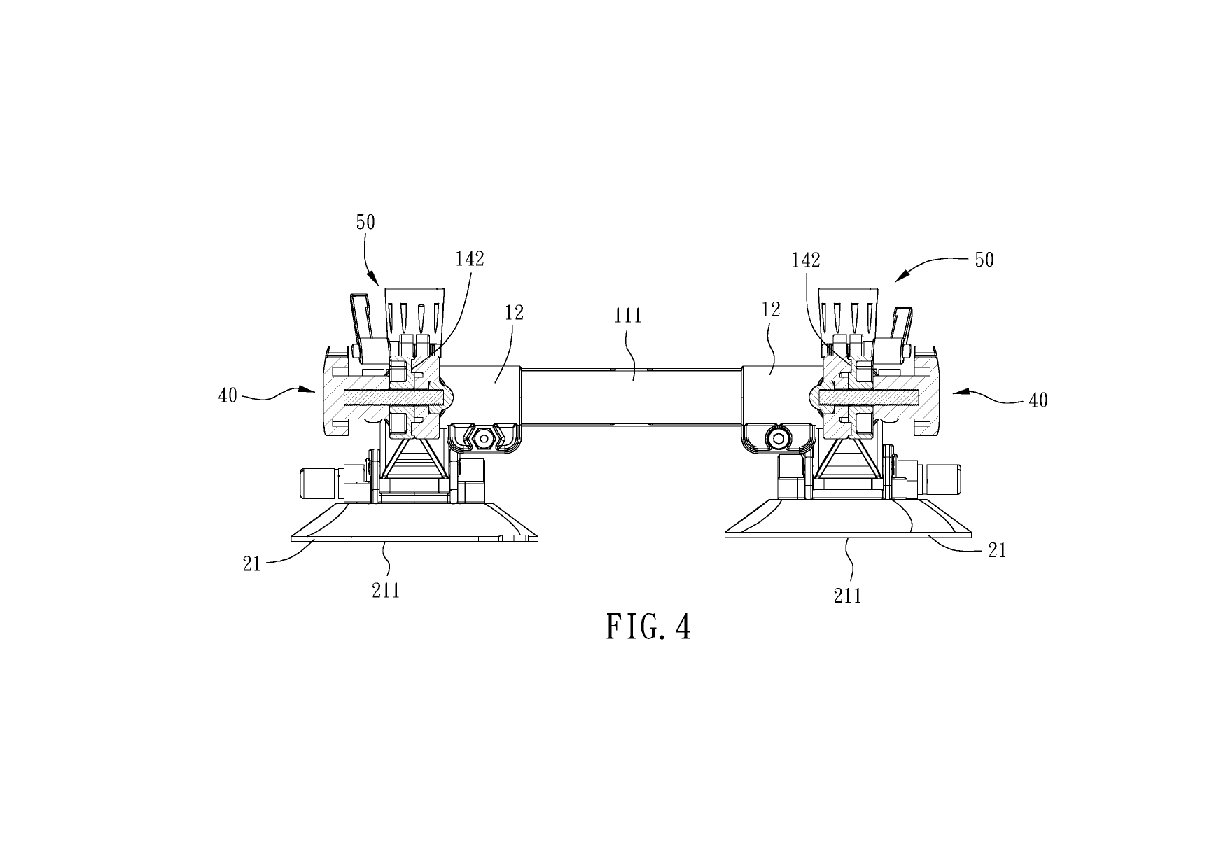

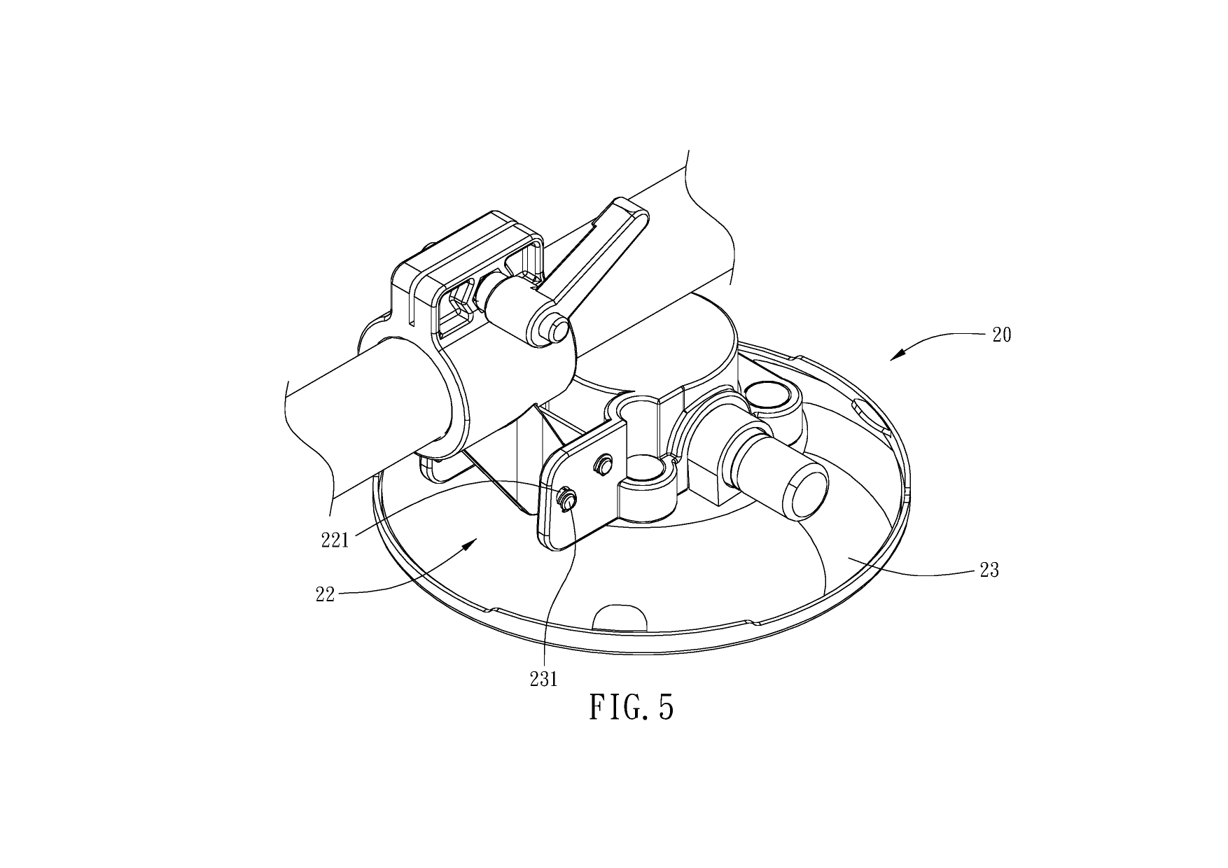

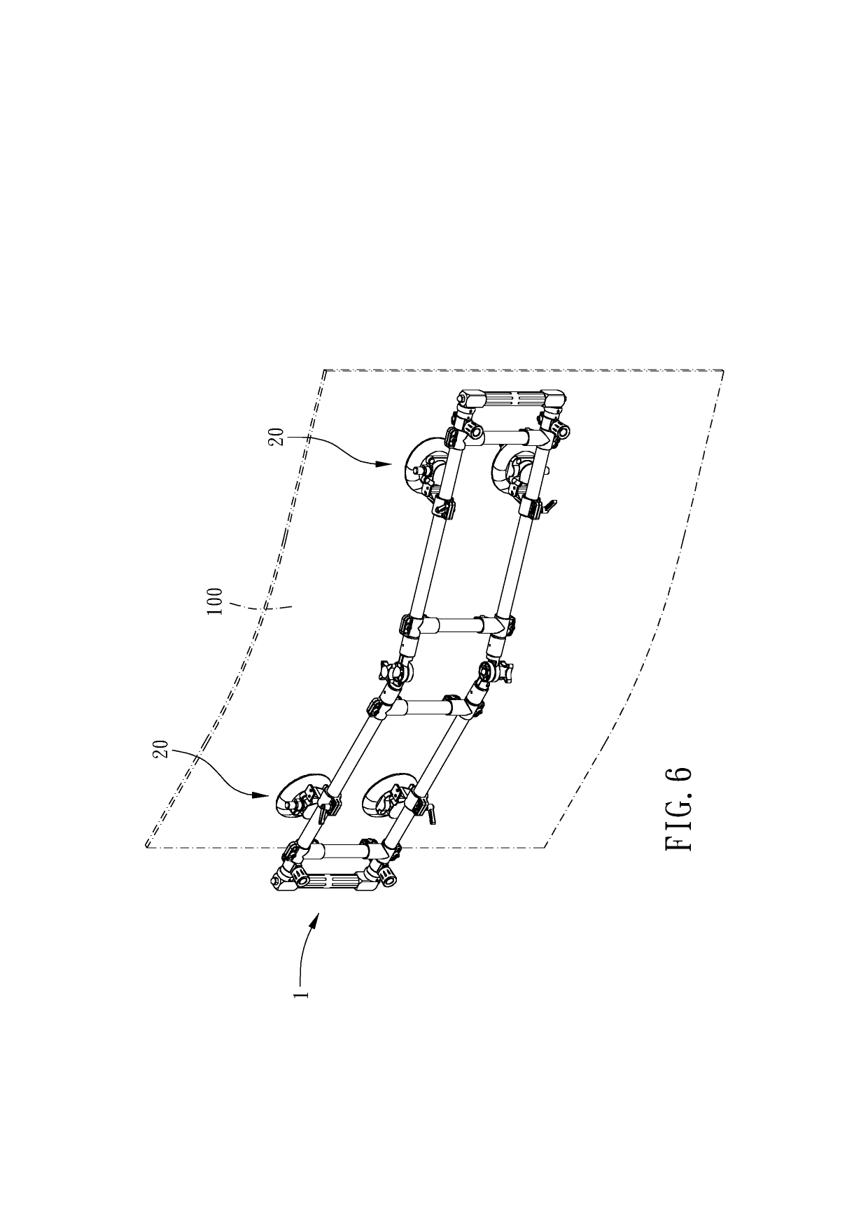

Please refer to FIGS. 1 to 6 for an exemplary embodiment of the present invention. A glass carrier 1 of the present invention includes a frame 10 and a plurality of suction devices 20.

The frame 10 includes two frame bodies 11, and the two frame bodies 11 are connected to each other and angularly adjustable relative to each other. The plurality of suction devices 20 are connected to the two frame bodies 11 respectively, each of the plurality of suction devices 20 includes a suction cup 21 including an attachment surface 211 configured to be air-tightly attached to a surface of a glass 100. An angle between the attachment surfaces 211 of two of the suction cups 21 of the plurality of suction devices 20 which are disposed respectively on the two frame bodies 11 is adjustable by adjusting an angle between the two frame bodies 11. As such, the glass carrier 1 can be adjusted within a large range to effectively attach to a flat, curved or angled surface, and is suitable for carrying glass of various surface types.

Specifically, each of the two frame bodies 11 includes a plurality of rods 111 which are detachable, the plurality of rods 111 are detachably connected to each other by a plurality of multi-way connectors 12, which is convenient for assembly, disassembly, repair, replacement, and storage, allows to expand the glass carrier 1 according to various requirements, or/and allows that the plurality of suction devices 20 can be increased or decreased in quantity. The plurality of rods 111 are each transversely connected to one another, so that it provides good structural strength and stability, and so that the plurality of suction devices 20 can be arranged at one of various positions of the two frame bodies 11, which can be stably and reliably attached to the glass. Preferably, the two frame bodies 11 further includes a grip bar 13 having an anti-slip structure 131, which is conducive to stable holding and use. Each said grip bar 13 may be detachably disposed on the plurality of rods 111 by, for example, a quick release fastening member 30 or other fasteners, which allows the easy assembly, disassembly and replacement according to various requirements.

Each of the two frame bodies 11 includes at least one connection head 14 including a positioning structure 141, and the positioning structures 141 of the connection heads 14 of the two frame bodies 11 are adjustably positioned to each other. In this embodiment, each of the two frame bodies 11 includes two connection heads 14. The connection heads 14 of the two frame bodies 11 are rotatably connected to each other and rotatable about a rotation axis, the positioning structure 141 of the connection head 14 of each of the two frame bodies 11 includes a plurality of teeth 142 arranged around the rotation axis, and the teeth 142 of the connection head 14 of the two frame bodies 11 are engaged with each other and positioned to each other by a locking assembly 40 or other fastener. As such, after adjusting the relative angle between the two frame bodies 11, the relative position and angle of the two frame bodies 11 can be fixed by tightening the locking assembly 40 or other fastener. The plurality of teeth 142 allow the two frame bodies 11 to relatively rotate within a large range (in this embodiment, 360 degrees), which is applicable to various surface angles and types of glass. Preferably, the connection head 14 of each of the two frame bodies 11 is detachable, which is convenient for assembly, disassembly, repair, replacement, and storage.

Preferably, the plurality of suction devices 20 are adjustably connected to the two frame bodies 11, and the plurality of suction devices 20 are detachably connected to the two frame bodies 11 by a plurality of quick release fastening members 50, so that the attachment positions of the plurality of suction devices 20 can be adjusted according to requirements, and so that the number of the plurality of suction devices 20 can be easily and quickly increased or decreased. The attachment surface 211 of at least one of the plurality of suction devices 20 is angularly adjustable relative to the frame 10. Specifically, at least one of the plurality of suction devices 20 includes a base 22 connected to the frame 10 and a suction assembly 23 connected to the base 22, the suction assembly 23 includes the suction cup 21, one of the base 22 and the suction assembly 23 includes a groove 221, an other of the base 22 and the suction assembly 23 includes a pin 231 movably inserted in the groove 221 so that, for a glass surface with a small angle variety, the swingable range of the suction device 20 can meet the need to effectively attach to the glass surface without adjusting the relative angle between the two frame bodies 11. Preferably, an adjustable range of the angle between the two frame bodies 11 is larger than an adjustable range of an angle between the attachment surface 211 and the frame 10, so that, for a glass surface with a large angle variety, the relative angle between the two frame bodies 11 can be adjusted, and the suction device 20 can be effectively and reliably attached to the glass surface.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A glass carrier including:
a frame including two frame bodies, the two frame bodies being connected to each other and angularly adjustable relative to each other; and
a plurality of suction devices connected to the two frame bodies respectively, each of the suction devices including a suction cup including an attachment surface configured to be air-tightly attached to a surface of a glass member;
wherein an angle between the attachment surfaces of two of the suction cups of the plurality of suction devices which are disposed respectively on the two frame bodies is adjustable by adjusting an angle between the two frame bodies.

2. The glass carrier of claim 1, wherein each of the two frame bodies includes a plurality of rods which are detachable.

3. The glass carrier of claim 2, wherein the plurality of rods are each transversely connected to one another.

4. The glass carrier of claim 1, wherein the plurality of suction devices are adjustably connected to the two frame bodies.

5. The glass carrier of claim 4, wherein the attachment surface of at least one of the plurality of suction devices is angularly adjustable relative to the frame.

6. The glass carrier of claim 4, wherein an adjustable range of the angle between the two frame bodies is larger than an adjustable range of an angle between the attachment surface and the frame.

7. The glass carrier of claim 3, wherein the plurality of rods are detachably connected to each other by a plurality of multi-way connector; the plurality of suction devices are detachably connected to the two frame bodies by a plurality of quick release fastening members; the attachment surface of at least one of the plurality of suction devices is angularly adjustable relative to the frame; at least one of the plurality of suction devices includes a base connected to the frame and a suction assembly connected to the base, the suction assembly includes the suction cup, one of the base and the suction assembly includes a groove, and an other of the base and the suction assembly includes a pin movably inserted in the groove; an adjustable range of the angle between the two frame bodies is larger than an adjustable range of an angle between the attachment surface and the frame; each of the two frame bodies further includes a grip bar having an anti-slip structure thereon; the grip bar is detachably disposed on the plurality of rods by a quick release fastening member.

8. The glass carrier of claim 1, wherein each of the two frame bodies includes at least one connection head including a positioning structure, and the positioning structures of the connection heads of the two frame bodies are adjustably positioned to each other.

9. The glass carrier of claim 8, wherein the connection heads of the two frame bodies are rotatably connected to each other and rotatable about a rotation axis, the positioning structure of the connection head of each of the two frame bodies includes a plurality of teeth arranged around the rotation axis, and the plurality of teeth of the connection heads of the two frame bodies are adjustably positioned to each other.

10. The glass carrier of claim 8, wherein the connection head of each of the two frame bodies is detachable.
